(19) United States
(12) Patent Application Publication
(10) Pub. No.: US 2016/0271912 A1
(43) Pub. Date: Sep. 22, 2016

(54) FLUORINATED COMPOSITION CONTAINING A UV ABSORBER AND USE OF SAME AS A TRANSPARENT PROTECTIVE LAYER

(71) Applicant: ARKEMA FRANCE, Colombes (FR)

(72) Inventors: Stephane BIZET, Barc (FR); Anthony BONNET, Saint Laurent de Mure (FR); Samuel DEVISME, Rouen (FR); Thomas Fine, Shanghai (CN); Barbara RAMFEL, Barc (FR)

(21) Appl. No.: 15/027,817

(22) PCT Filed: Oct. 6, 2014
(86) PCT No.: PCT/FR2014/052520

§ 371 Date: Apr. 7, 2016

(30) Foreign Application Priority Data
Oct. 9, 2013 (FR) 1359784

(51) Int. Cl. B32B 27/08; B32B 27/28; B32B 27/40; B32B 27/34; B32B 27/36; C08J 5/18; B32B 27/32

(52) U.S. Cl. CPC B32B 27/08; C08J 5/18; B32B 27/281; B32B 27/32; B32B 27/34; B32B 27/36; B32B 27/40; C08J 2327/16; C08J 2433/12; B32B 2457/12; B32B 2307/714; B32B 2307/412; B32B 2262/101; B32B 2307/306

(57) ABSTRACT

The present invention concerns compositions made from fluorinated polymers and the uses of same in order to produce transparent monolayer or multilayer films intended to protect various substrates. The polymer composition consists of at least one polymer made from vinylidene fluoride, at least one acrylic polymer and at least one UV absorber, the mass ratio of said fluorinated polymer being 60 and 90%, the mass ratio of said UV absorber being from 0.5 to 5% and the molecular weight of the latter is greater than 500 g/mol.

### FIELD OF THE INVENTION

A subject matter of the present invention is compositions based on fluoropolymers and their uses in the manufacture of transparent monolayer or multilayer films intended to protect various polymer substrates, in particular the back sheet of solar panels.

### TECHNICAL BACKGROUND

Protective layers based on fluoropolymers often comprise inorganic fillers which make it possible to completely or partially absorb the UV radiation of the spectrum of the sun, in order to minimize the degradation of said polymers and the substrates to be protected. This very efficient technology exhibits a disadvantage of resulting in nontransparent films (films exhibiting less than 90% of transmission). However, for the majority of industrial applications, transparency constraints are imposed: the material must not absorb in the visible region. There exists a real need for a transparent protective layer which cuts off UV rays, whether in solar panels or for other applications, such as the protection of sheets/plaques for external use.

It is known to use organic UV absorbers to prevent mechanisms of degradation of polymers by photooxidation, cleavages of chains, crosslinkings or an uncontrolled recombination reaction during exposure to UV radiation. These components make it possible to dissipate light absorbed during exposure to UV radiation by an intramolecular proton transfer mechanism. UV absorbers exhibit at least one absorbance peak in the UV wavelength region.

One of the limitations on use of these UV absorbers in compositions containing fluoropolymers lies in the migration of these molecules to the surface of the polymer material, known as exudation, due to the low compatibility of said components.

The applicant company has already described, in the document EP 1 382 640, bilayer PVDF/composition coextrudable with the PVDF protective films, said composition consisting of from 20 to 40 parts of polyvinylidene fluoride (PVDF), from 40 to 60 parts of PMMA, from 5 to 18 parts of an acrylic elastomer and from 1 to 4 parts of a UV absorber, the total corning to 100 parts. These films exhibit good mechanical properties which are sufficient to allow them to be handled, to be processed and to be used as coating transparent to visible light but opaque to UV radiation. No exudation is observed after 7 days spent in an oven. However, the mechanical strength with regard to temperature or the chemical resistance of these films still leaves something to be desired, in particular because of the high percentage by weight of PMMA.

Furthermore, it is known to use fluoropolymers in general and in particular PVDF (polyvinylidene fluoride) to manufacture fluorinated films intended to protect the back faces (also known as back sheets) of photovoltaic panels, due to their very good resistance to bad weather, to ultraviolet radiation, to visible light and to chemicals. These fluorinated films exhibit a very good thermal resistance, which allows them to endure severe weather conditions (rain, cold, heat), and also good flexibility and a good breaking strength, so as to withstand the mechanical stresses during their positioning on the photovoltaic panel.

There still exists a need to have available fluorinated films which combine all the

abovementioned characteristics and are thus capable of protecting various substrates from the detrimental effects of UV and visible radiation, while conferring good chemical resistance and good resistance to bad weather.

There very particularly exists a need to develop novel protective layers exhibiting both optical properties, such as transparency in the visible region and absorbance of UV radiation, and durability properties, such as long-term resistance to UV radiation and resistance to damp heat, that is to say no mechanical embrittlement of the film.

### SUMMARY OF THE INVENTION

According to a first aspect, the invention relates to a polymer composition consisting of at least one polymer based on vinylidene fluoride (known as PVDF), at least one acrylic polymer (known as PMMA) and at least one UV absorber, in which the proportion by weight of said fluoropolymer varies from 60 to 90%, the proportion by weight of said UV absorber varies from 0.5 to 5% and the molecular weight of the latter is greater than 500 g/mol.

The polymer based on vinylidene fluoride (known as PVDF) is chosen from vinylidene fluoride homopolymers and copolymers of vinylidene fluoride and of at least one other fluoro monomer. The proportion by weight of PVDF varies from 60 to 90% of the weight of the composition, preferably from 60 to 80%, The UV absorber is selected from benzophenones, benzotriazoles, triazines, cyanoacrylates and oxalanilides having a molecular weight of greater than 500 g/mol, this list not being exclusive. Advantageously, the UV absorber is chosen from 1,3-bis[(2′-cyano-3′,3′-diphenylacryloyl)oxy]-2,2-bis{[(2′-cyano-3′,3′-diphenylacryloyl)oxy]methyl}propane, 2,2′-methylenebis(6-(2H-benzotriazol-2-yl)-4-(1,1,3,3-tetramethylbutyl)phenol), 2-[4,6-bis(2,4-dimethylphenyl)-1,3,5-triazin-2-yl]-5-(octyloxy)phenol or poly(4-(2-acryloyloxyethoxy)-2-hydroxybenzophenone. These four products correspond respectively to Uvinul® 3030, Tinuvin® 360, Cyasorb® 1164 and Cyasorb® 2126.

Another subject matter of the invention is monolayer or multilayer films intended to protect various polymer substrates manufactured from the composition described above.

The invention also relates to a process of manufacture of a multilayer structure comprising at least one layer consisting of the composition described above.

Another subject matter of the invention is the use of the composition described above to protect the back face of a photovoltaic panel.

The present invention makes it possible to overcome the abovementioned disadvantages of the state of the art. It more particularly provides a novel polymer composition exhibiting, in addition to transparency in the visible region and absorbance of UV radiation, improved properties of durability, such as long-term resistance to UV radiation and resistance to damp heat. This composition makes it possible to manufacture transparent films having improved high-temperature mechanical properties while avoiding the phenomenon of exudation of the UV absorber. These films are suitable for the protection of various polymer substrates. The composition according to the invention is particularly suitable for the protection of the back face of a photovoltaic panel. This is achieved by combining, with a PVDF polymer present in a proportion by weight of 60 to 90%, a PMMA polymer and at least one UV absorber at a content ranging from 0.5 to 5% by weight, of the total weight of the composition, said UV absorber having a molecular weight of greater than 500 g/mol.

### DESCRIPTION OF EMBODIMENTS OF THE INVENTION

The invention is now described in more detail and without implied limitation in the description as follows.

As regards the fluoropolymer, this denotes PVDFs, vinylidene fluoride (VDF, CH₂═CF₂) homopolymers and copolymers of VDF preferably containing at least 50% by weight of VDF and at least one other fluoro monomer which is copolymerizable with VDF. Preferably, the PVDF contains, by weight, at least 50% of VDF, most preferably at least 75% and better still at least 85%.

Use may be made, as comonomers, of: hexafluoropropylene (HFP), tetrafluoroethylene (TFE), vinylidene fluoride (VDF, CH₂═CF₂), chlorotrifluoroethylene (CTFE), perfluoroalkyl vinyl ethers, such as CF₃—O—CF═CF₂, CF₃—CF₂—O—CF═CF₂ or CF₃—CF₂CF₂—O—CF═CF₂, 1-hydropentafluoropropene, 2-hydropentafluoropropene, dichlorodifluoroethylene, trifluoroethylene (VF₃), 1,1-dichlorofluoroethylene and their blends, or fluorine-comprising diolefins, for example dioiefins such as perfluorodiallyl ether and perfluoro-1,3-butadiene.

The fluoropolymers which may participate in the composition according to the invention are chosen from:
TFE homo- or copolymers, in particular PTFE (polytetrafluoroethylene), ETFE (ethylene/tetrafluoroethylene copolymer) and TFE/PMVE (tetrafluoro-ethylene/perfluoro(methyl vinyl) ether copolymer), TFE/PEVE (tetra-fluoroethylene/perfluoro(ethyl vinyl) ether copolymer), TFE/PPVE (tetrafluoroethylene/perfluoro(propyl vinyl) ether copolymer) and E/TFE/HFP (ethylene/-tetrafluoroethylene/hexafluoropropylene terpolymers) copolymers;
VDF homo- or copolymers, in particular PVDF and VDF/HFP copolymers;
CTFE homo- or copolymers, in particular PCTFE (polychlorotrifluoroethylene) and E/CTFE (ethylene/chlorotrifluoroethylene copolymer).

Preferably, the fluoropolymer is a VDF homopolymer or a copolymer of VDF and of at least one other fluoromonomer.

Advantageously, the fluorocomonomer which can copolymerize with the VDF is chosen, for example, from vinyl fluoride, trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers, such as perfluoro(methyl vinyl) ether (PMVE), perfluoro(ethyl vinyl) ether (PEVE) and perfluoro(propyl vinyl) ether (PPYE); perfluoro(l,3-dioxole); perfluoro(2,2-dimethyl-1,3-dioxole) (PDD), and their blends.

Preferably, the fluorocomonomer is chosen from chlorotrifluoroethylene (CTFE), hexafluoropropylene (HFP), trifluoroethylene (VF3) and tetrafluoroethylene (TFE), and their blends. The comonomer is advantageously HFP as it copolymerizes well with VDF and makes it possible to contribute good thermomechanical properties. Preferably, the copolymer comprises only VDF and HFP.

Preferably, the fluoropolymer is a VDF homopolymer (PVDF) or a VDF copolymer, such as VDF/HFP, comprising at least 50% by weight of VDF, advantageously at least 75% by weight of VDF and preferably at least 90% by weight of VDF. Mention may be made, for example, more particularly of the following VDF homopolymers or copolymers comprising more than 75% of VDF and the remainder of HFP: Kynar® 710, Kynar® 720, Kynar® 740, Kynar Flex® 2850 and Kynar Flex® 3120, sold by Arkema. Advantageously, the composition according to the invention comprises two distinct fluoropolymers, at least one of which is a VDF homopolymer.

Advantageously, the fluoropolymer has a viscosity ranging from 100 Pa·s to 3000 Pa·s, the viscosity being measured at 230° C. at a shear gradient of 100 s⁻¹ using a capillary rheometer. This is because this type of polymer is well suited to extrusion. Preferably, the polymer has a viscosity ranging from 500 Pa·s to 2900 Pa·s.

The acrylic polymer (or acrylate) is a methyl methacrylate (MMA) homopolymer or a

copolymer comprising at least 50% by weight of MMA and at least one other monomer which can eopolymerize with MMA. Comonomers which can copolymerize with MMA are alkyl (meth)acrylates, acrylonitrile, butadiene, styrene or isoprene.

Advantageously, the acrylic polymer (MMA homopolymer or copolymer) comprises, by weight, from 0 to 20% and preferably from 5 to 15% of a C₁-C₈ alkyl (meth)acrylate, which is preferably methyl acrylate and/or ethyl acrylate. The acrylic polymer can be functionalized, that is to say that it comprises, for example, acid, acid chloride, alcohol or anhydride functional groups. Advantageously, the functionality is in particular the acid functional group introduced by the acrylic acid comonomer. Use may also be made of a monomer comprising two neighbouring acrylic acid functional groups which can dehydrate to form an anhydride. The proportion of functionality can be from 0 to 15% by weight of the MMA polymer.

As regards the UV absorber, it can, for example, concern the additives cited in the patent U.S. Pat. No. 5,256,472. Use is advantageously made of the compounds of benzotriazole, benzophenone, benzylidenemalonate or quinazoline type. A UV stabilizer of HALS (Hindered Amine Light Stabilizer) type can be used in combination with the UV absorber.

Advantageously, the UV absorber is chosen from 1,3-bis[(2′-cyano-3′,3′-diphenylacryloyl)oxy]-2,2-bis{[(2′-cyano-3′,3′-diphenylacryloyl)oxy]methyl}propane, 2,2′-methylenebis(6-(2H-benzotriazol-2-yl)-4-(1,1,3,3-tetramethylbutyl)phenol) 2-[4,6-bis(2,4-dimethylphenyl)-1,3,5-triazin-2-yl]-5-(octyloxy)phenol or poly(4-(2-acryloyloxyethoxy)-2-hydroxybenzophenone. These four products correspond respectively to Uvinul® 3030, Tinuvin® 360, Cyasorb® 1164 and Cyasorb® 2126.

According to one embodiment, the composition according to the invention consists of a fluoropolymer based on VDF (60 to 90% by weight), an acrylic polymer and a UV absorber with a molecular weight of greater than 500 g/mol. the content by weight of which varies from 0.5 to 5%.

According to one embodiment, the composition according to the invention consists of 68.6% of PVDF homopolymer (such as the product sold by Arkema under the name Kynar® 740), 29.4% of BS580 PMMA and 2% of Uvinul® 3030.

The composition according to the invention makes it possible to manufacture monolayer films which can be used to protect various polymeric substrates.

The constituents of the composition are blended by any method which makes it possible to obtain a homogeneous blend of fluoropolymer, acrylic polymer and UV absorber participating in the composition according to the invention.

More particularly, the composition according to the invention is prepared by melt blending all these constituents and is then transformed, for example in the form of granules by compounding on a device known to a person skilled in the art, such as a twin-screw extruder, a co-kneader or a mixer. This composition can either be coextruded with another material or extaided in the form of a film.

The film according to the invention can be manufactured by blown film extrusion at a temperature ranging from 220 to 260° C. This technique consists in coextruding, generally from the bottom upwards, a thermoplastic polymer through an annular die. The extrudate is simultaneously drawn longitudinally by a drawing device, usually in the form of rolls, and inflated with a constant volume of air trapped between the die, the drawing system and the wall of the tube. The inflated tube is generally cooled by an air-blowing ring at the die outlet.

The film can also be manufactured by cast film extrusion; this process consists in drawing, in air, a sheet or a film of polymer between a flat die and a thermostatically controlled roll. It makes it possible to manufacture sheets with a thickness of between 0.2 mm and 2 mm and films with a thickness of less than 0.2 mm.

The thickness of the film varies from 5 to 500 microns, preferably from 10 to 50 microns, limits included. The transparency of the monolayer film according to the invention is greater than 90% in the range from 400 to 800 nm. The film exhibits a UV absorbance of at least 1 from 280 nm to 380 nm.

According to another aspect, a subject matter of the invention is a transparent multilayer film comprising at least one layer consisting of the composition described above. The transparency of this multilayer film is greater than 90% in the range from 400 to 800 nm. The film exhibits a UV absorbance of at least 1 from 280 nm to 380 nm. Its thickness is from 5 to 500 microns.

According to one embodiment, the film consists of two layers, an internal layer being as described above and an external layer which comprises from 100 to 0% of PVDF and from 0 to 40% of PMMA. In this case, the ratio by weight of the internal layer to the external layer varies from 90/10 to 50/50.

According to one embodiment, the film consists of three layers, namely an internal layer which comprises from 100 to 0% of PVDF and from 0 to 40% of PMMA, a central layer comprising a UV absorber as described above and an external layer comprising from 100 to 0% of PVDF and from 0 to 40% of PMMA.

A multilayer film according to the invention is preferably manufactured by the coextrusion technique, for example by blown film coextrusion. but it is also possible to use cast film extrusion or a technique for processing by the solvent route or else using the acrylic resin coating technique.

According to another aspect, a subject matter of the invention is the use of a (monolayer or multilayer) film for the protection of various polymeric substrates, such as substrates made of: polyester (for example poly(ethylene terephthalate)s, poly(ethylene naphthalate)s or polybutylene terephthalate), polycarbonate, polyolefin (for example polypropylene, thermoplastic polyolefms, high density polyethylenes, poly(cyclic olefin)s), polystyrene (for example syndiotactic polystyrenes), styrene/acrylate copolymers, acrylonitrile/styrene copolymers (for example ABS, ASA or SAN), polysulfone (for example polyethersulfones, polysulfones, and the like), polyurethanes (aliphatic ether or aliphatic ester or aromatic ether or aromatic ester or thermo plastics of ester polyurethanes), acrylic polymers (PMMA), polyvinyl chloride (PVC), chlorinated PVC (CPVC) or expanded PVC, poly(phenylene ether) (PPE), polyacetals, polyamide-based resins, polyimide-based resins or polyamideimide-based resins, A blend of two or more thermoplastic polymers from the preceding list may also be concerned. For example, a PPO/PS or PC/ABS blend may be concerned.

The film according to the invention can also be used to protect a flexible substrate, such as, for example, a technical textile (made of PVC, glass fabric, glass mat, aramid, Kevlar® or poly(p-phenylene terephthalamide)). A tarpaulin made of PVC constitutes an example of flexible substrate made of PVC. The film can be applied via an adhesive layer using the rolling technique. The adhesives which are used, by way of example, are polyester formulations or polyurethanes comprising methyl ethyl ketone (MEK) or toluene.

According to another aspect, a subject matter of the invention is the use of a (monolayer or multilayer) film in the manufacture of the back face in a photovoltaic panel To this end, according to one embodiment, the film according to the invention is first subjected, on both its faces, to a surface treatment of corona type. Subsequently, it is hot rolled on each side with a PET sheet coated beforehand with adhesive. One of the faces of the laminate thus obtained is subsequently pressed against a film of EVA type, the other face of the latter being adhesively bonded to a cleaned glass plate. This structure can be used as back sheet in a photovoltaic cell.

The invention also relates to a photovoltaic panel, the back face of which is protected by said film.

The film according to the invention exhibits the following advantages:
very good transparency in the visible region, with a transmission of greater than 90% for the range of wavelengths extending from 400 nm to 800 nm;
a good chemical resistance (better than 100% PMMA), in particular in the case of a multilayer film;
a good barrier effect to UV radiation (absorbance of greater than 1.5 at 360 nm) which is lasting, as shown by the QUVA tests and the damp heat test.

A better understanding of the present invention will be obtained in the light of the implementational examples which will follow.

### Materials of the Study

PVDF 1: —“PVDF” is a vinylidene fluoride homopolymer having an MFR of 17.5-22.5 g/10 min (230° C.; 3.8 kg), a melting point (M.p.) of 169° C. and a Young's modulus ranging from 1800 to 2000 MPa at 23° C., The M.p. was measured by DSC or differential scanning calorimetry. The elastic moduli were measured according to the standard ISO 527.
PMMA: The PMMA used is an Altuglas BS 550 grade (copolymer of methyl methacrylate with 11-12% of ethyl acrylate—MFR 17-20 g/10 min (230° C.; 3.8 kg) - MW: 70 000-80 000 g/mol).
PE: polyethylene of LDPE type from Exxon, LD165BW1 grade (MFR 03 g/10 min (190° C.; 2.16 kg), density=0.922 g/cm³).
UV absorbers: they are listed in table 1.

TABLE 1

| | Commercial name | | | | |
|---|---|---|---|---|---|
| | Tinuvin ® | Cyasorb ® | Uvinul ® | Tinuvin ® | Cyasorb ® |
| | 234 | 1164 | 3030 | 1577 | 3638F |
| Supplier | BASF | Cytec | BASF | BASF | Cytec |
| Family | triazole | triazine | cyano- | triazine | benzoate |
| | | | acrylate | | |
| Molar | 447.6 | 509.7 | 1061 | 425.5 | 368.4 |
| mass | | | | | |
| (g/mol) | | | | | |

### Example 1

Compounding: The compounded products are produced according to the rules of the art on a corotating twin-screw extruder. The compositions of the test are shown in table 2.

TABLE 2

| | | Composition | | | |
|---|---|---|---|---|---|
| Example/ | | % | % | | |
| Counter- | Compounded | PVDF | PMMA | UV | % UV |
| example | Product No. | 1 | 1 | absorber | absorber |
| E1 | Compounded | 68.6 | 29.4 | Uvinul ® | 2 |
| | Product 1 | | | 3030 | |
| E2 | Compounded | 68.6 | 29.4 | Cyasorb ® | 2 |
| | Product 2 | | | 1164 | |
| CE1 | Compounded | 68.6 | 29.4 | Tinuvin ® | 2 |
| | Product 3 | | | 234 | |
| CE2 | Compounded | 68.6 | 29.4 | Tinuvin ® | 2 |
| | Product 4 | | | 1577 | |
| CE3 | Compounded | 68.6 | 29.4 | Cyasorb ® | |
| | Product 5 | | | 3638F | |

Film extrusion: The films are subsequently produced by blown film extrusion on a 5-layer laboratory line having a pancake die (diameter 50 mm, gap 1.2 mm). The films exhibit a symmetrical PE/PVDF/PVDF/PVDF/PE structure. The processing conditions used to prepare the films are as follows:
blow-up ratio: 2.55;
total throughput: 14.7 kg/h, drawing rate: 6.9 m/min,
extrusion temperature=PE (230° C.), PVDF and Compounded Product 1 (240° C.), die (240° C.).
   The PE film is subsequently delaminated in order to obtain a 100% fluorinated film.

### Analysis of the Films by the Damp Heat Test

The films are placed in a climate-controlled chamber at 85° C./85% RH (relative humidity) for 1000 h. The films are subsequently analyzed by UV/visible spectrometry in order to quantify the UV absorbance and the exudation. The films were analyzed by UV/visible spectrometry on the Gary 300 transmission spectrometer with the cell holder and integrating sphere accessories. The integrating sphere makes it possible to measure the total transmission. The analysis in transmission with the cell holder accessory does not take into account the scattering effect of the material.

### Analytical Conditions:

spectral range: 200-800 nm
mean time: 0.2 s
data interval: 1 nm
scanning frequency: 300 nm/min
   The exudation is quantified by taking the ratio of the transmission, measured at 700 nm in the “sphere” configuration, to the transmission, measured at 700 nm in the “cell holder” configuration, on monolayer films extruded by blown film extrusion (30 microns). This ratio is determined before the test and after testing for 2000 h.

TABLE 3

| | | 700 nm | | | | | | |
|---|---|---|---|---|---|---|---|---|
| | time | cell | | sphere | | C/S | S/S | C/S |
| | (h) | 0 | 2000 | 0 | 2000 | 0 | 2000 | 2000 |
| CE1 | T234 | 93.0 | 38.3 | 93.0 | 86.0 | 1.00 | 0.92 | 0.45 |
| CE2 | T1577 | 90.0 | 45.6 | 90.2 | 90.4 | 1.00 | 1.00 | 0.50 |
| E1 | U3030 | 90.5 | 64.2 | 91.0 | 90.4 | 0.99 | 0.99 | 0.71 |

The results presented in table 3 show that the exudation is much lower in the case of the use of a UV absorber with a molecular weight of greater than 500 g/mol.

### Example 2

Films are produced by blown film extrusion starting from the compounded products mentioned in example 1. These films are monolayers with a thickness of 30 microns or PVDF/Compounded Product /PVDF multilayers (5/25/5 microns)
Extrusion of the film: The films are subsequently produced by blown film extrusion on a 5-layer laboratory line having a pancake die (diameter 50 mm, gap 1.2 mm). The films exhibit a symmetrical PE/PVDF/PVDF/PVDF/PE structure. The processing conditions used to prepare the films are as follows:
blow-up ratio: 2.55;
total throughput: 14.7 kg/h, drawing rate: 6.9 m/min,
extrusion temperature=PE (230° C.), PVDF and Compounded Product 1 (240° C.), die (240° C.).
   The PE film is subsequently delaminated in order to obtain a 100% fluorinated film.
   The films are subsequently placed in a PCT (Pressure Cooker Test->accelerated test of aging in water placed in an autoclave 120° C., 30 h). The exudation is characterized with a naked eye before and after cleaning the surface with a rag. The results are shown in table 4.

TABLE 4

| Example/ | | | | |
|---|---|---|---|---|
| Counter- | | Compounded | Exudation | After cleaning |
| example | Film | Product No. | Before | with a rag |
| E3 | monolayer | Compounded | low | no trace of |
| | | Product 1 | | exudation |
| E4 | monolayer | Compounded | low | a few traces |
| | | Product 2 | | after cleaning |
| E5 | trilayer | Compounded | very | no trace of |
| | | Product 1 | low | exudation |
| E6 | trilayer | Compounded | low | a few traces |
| | | Product 2 | | after cleaning |
| CE4 | monolayer | Compounded | very | traces still |
| | | Product 3 | high | visible after |
| | | | | cleaning |
| CE5 | monolayer | Compounded | high | a few traces |
| | | Product 4 | | after cleaning |
| CE6 | monolayer | Compounded | high | a few traces |
| | | Product 5 | | after cleaning |

The examples from 3 to 6 show once again that it is necessary to use a UV absorber with a molecular weight of greater than 500 g/mol in order to have a low exudation after aging in a damp environment (see CE4 to CE6). The fact of adding a layer of fluoropolymer not formulated with a UV absorber at the surface makes it possible to slow down the exudation.

1. A polymer composition comprising at least one polymer based on vinylidene fluoride, at least one acrylic polymer and at least one UV absorber, wherein the proportion by weight of said fluoropolymer varies from 60 to 90%, the proportion by weight of said UV absorber varies from 0.5 to 5% and whereto the UV absorber has a molecular weight greater than 500 g/mol.

2. The composition as claimed in claim 1, wherein said polymer based on vinylidene fluoride is chosen from vinylidene fluoride homopolymers, and copolymers of vinylidene fluoride with least one other fluoromonomer.

3. The composition as claimed in claim 1 wherein said acrylic polymer is a methyl methacrylate homopolymer or a copolymer comprising at least 50% by weight of methyl methacrylate and at least one other monomer which can copolymerize with methyl methacrylate chosen from alkyl (meth)acrylates, acrylonitrile, butadiene, styrene and isoprene.

4. The composition as claimed in claim 1 wherein the proportion by weight of the polymer based on vinylidene fluoride varies from 60 to 80%.

5. The composition as claimed in claim 1 wherein said UV absorber is the group consisting of from benzophenones, benzotriazoles, triazines, cyanoacrylates and oxalanilides: 1,3-bis[(2′-cyano-3′,3′-diphenylacryloyl)oxy]-2,2-bis{[(2′-cyano-3′,3′-diphenylacryloyl)oxy]methyl}propane, 2,2′-methylenebis(6-(2H-benzotriazol-2-yl)-4-(1,1,3,3-tetramethylbutyl)phenol), 2-[4,6-bis(2,4-dimethylphenyl)-1,3,5-triazin-2-yl]-5-(octyloxy)phenol and poly(4-(2-acryloyloxyethoxy)-2-hydroxybenzophenone.

6. A film consisting of the polymer composition as claimed in claim 1, said film having a transparency of greater than 90% in the range from 400 to 800 nm and a UV absorbance of at least 1 from 280 nm to 380 nm.

7. The film as claimed in claim 6, having a thickness ranging from 5 to 500 microns.

8. The film as claimed in claim 6 wherein said film is a multilayer film

9. The multilayer film as claimed in claim 8, wherein said multilayer film is film comprising a first and second layer, and wherein the second layer comprises from 100 to 0% of PVDF and from 0 to 40% of PMMA.

10. The multilayer film as claimed in claim 8, wherein said film is a tri layer film comprising a first external layer, an internal layer and a second external layer, and wherein the internal layer consists of the composition as claimed in claim 1 and the external layers comprise from 100 to 0% of PVDF and from 0 to 40% of PMMA.

11. The multilayer film as claimed in claim 8, having a thickness ranging from 10 to 500 microns.

12. A process for the manufacture of the monolayer film as claimed in claim 6 by blown film extrusion at a temperature ranging from 220 to 260° C. or by east film extrusion.

13. (canceled)

14. An article comprising the film as claimed in claim 6, adhering to and protecting a polymeric substrate, wherein said substrate is selected from the group consisting of:
a. polyester, polycarbonate, polyolefin, polystyrene, styrene/acrylate copolymers, acrylonitrile/styrene copolymers, polysulfone, polyurethanes, acrylic polymers, polyvinyl chloride, poly(phenylene ether), polyacetals, polyamide-based resins, polyimide-based resins and polyamideimide-based resins,
b. the blend of two or more polymers from the list in a,
c. and technical textiles made of: PVC, glass fabric, glass mat, aramid and poly(p-phenylene terephthalamide).

15. The article as claimed in claim 14 wherein said article is a photovoltaic panel comprising said film for the protection of its back face.
